(19) United States
(12) Patent Application Publication
(10) Pub. No.: US 2017/0264874 A1
(43) Pub. Date: Sep. 14, 2017

(54) PROJECTION APPARATUS

(71) Applicant: Panasonic Intellectual Property Management Co., Ltd., Osaka (JP)

(72) Inventor: KEIGO ONO, Osaka (JP)

(21) Appl. No.: 15/417,300

(22) Filed: Jan. 27, 2017

(30) Foreign Application Priority Data
Mar. 8, 2016 (JP) 2016-044849
Jan. 5, 2017 (JP) 2017-000319

(51) Int. Cl. H04N 9/31

(52) U.S. Cl. CPC H04N 9/3188; H04N 9/3194

(57) ABSTRACT

The projection apparatus includes a projector, a detector, and a controller. The projector projects a projection image on a predetermined projection surface. The detector detects an object on the predetermined projection surface. The controller controls the projection image. The controller specifies a predetermined target object out of the object on the basis of the detection result of the detector. The controller specifies a free space, on which the object is not detected, on the predetermined projection surface on the basis of the detection result of the detector. The controller causes the projector to project content concerning the predetermined target object within a range of the free space by controlling the projection image including the content.

### BACKGROUND

1. Technical Field

The present disclosure relates to a projection apparatus that projects an image.

2. Description of the Related Art

Unexamined Japanese Patent Publication No. 2015-139177 discloses an image projection system that aims to project an image with high visibility according to the ambient environment. The image projection system described above identifies an article in an image captured by an image-capturing unit in an existing camera in a shop, for example, to detect an article region where articles are present. The image projection system described above projects a black image in the detected article region, while projects an image such as information about bargain priced articles in a region other than the detected article region.

### SUMMARY

The present disclosure provides a projection apparatus that is able to project content concerning a target object on a projection surface around the target object in such a way that a viewer is easy to see the content.

The projection apparatus according to the present disclosure includes a projector, a detector, and a controller. The projector projects a projection image on a predetermined projection surface. The detector detects an object on the predetermined projection surface. The controller controls the projection image. The controller specifies a predetermined target object out of the object on the basis of the detection result of the detector. The controller specifies a free space, on which the object is not detected, on the predetermined projection surface on the basis of the detection result of the detector. The controller causes the projector to project content concerning the predetermined target object within a range of the free space by controlling the projection image including the content.

According to the projection apparatus in the present disclosure, the content concerning the target object out of the object, which have been detected, is projected in a free space not overlapping the object on the projection surface on the basis of the detection result of the object. Thus, the content concerning the target object is projected so as to be easily seen by a viewer on the projection surface around the target object.

### BRIEF DESCRIPTION OF THE DRAWINGS

FIG. 1 is a view illustrating a state in which a projection apparatus according to a first exemplary embodiment projects an image onto a wall;

FIG. 2 is a view illustrating a state in which the projection apparatus projects an image onto a table;

FIG. 3 is a block diagram illustrating the electric configuration of the projection apparatus;

FIG. 4A is a block diagram illustrating the electric configuration of a range detection unit;

FIG. 4B is a block diagram for describing a range image;

FIG. 5 is a block diagram illustrating the optical configuration of a projector;

FIG. 6 is a diagram for describing a content database;

FIG. 7 is a view for describing a projection operation by the projection apparatus;

FIG. 8 is a view for describing a projection operation when an object other than a target object is placed;

FIG. 9 is a flowchart for describing a projection operation by the projection apparatus;

FIG. 10 is a flowchart illustrating a process for specifying a free space;

FIG. 11A is a diagram illustrating a range image;

FIG. 11B is a diagram illustrating a specifying result of free spaces;

FIG. 12 is a flowchart illustrating a process for sorting free spaces;

FIG. 13 is a flowchart illustrating a process for calculating the distance to a target object;

FIG. 14A is a diagram for describing the process for calculating the distance to a target object;

FIG. 14B is a diagram for describing the process for calculating the distance to a target object;

FIG. 15 is a flowchart illustrating a process for determining content;

FIG. 16 is a view for describing a projection operation by a projection apparatus according to a second exemplary embodiment;

FIG. 17 is a flowchart illustrating a process for sorting free spaces in the second exemplary embodiment; and

FIG. 18 is a flowchart illustrating a process for determining content in the second exemplary embodiment.

### DETAILED DESCRIPTION

Exemplary embodiments will be described below in detail with reference to the drawings as necessary. However, more than necessary detailed descriptions will sometimes be omitted. For example, detailed descriptions for matters which have already been well known in the art and redundant descriptions for substantially the same configurations will sometimes be omitted. This is to prevent the description below from becoming unnecessarily redundant to facilitate understanding of a person skilled in the art.

Note that the accompanying drawings and the following description are provided by the applicant in order for a person of ordinary skill in the art to sufficiently understand the present disclosure, and they are not intended to limit the subject matter set forth in the claims.

### FIRST EXEMPLARY EMBODIMENT

Projection apparatus 100 will be described as a specific embodiment of a projection apparatus according to the present disclosure.

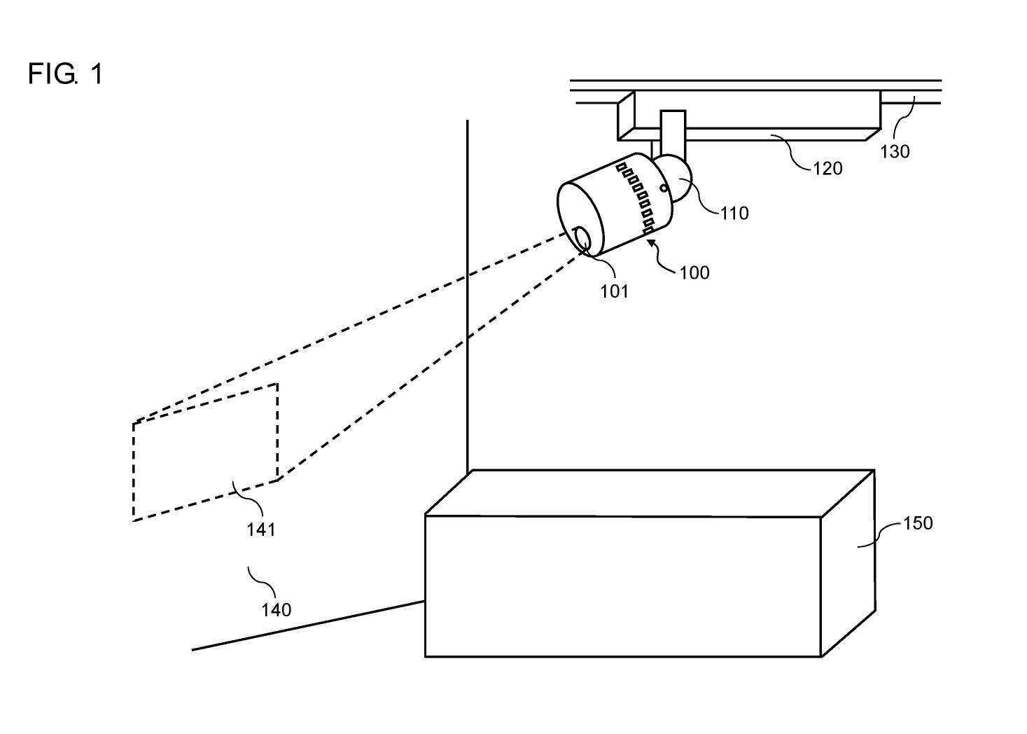

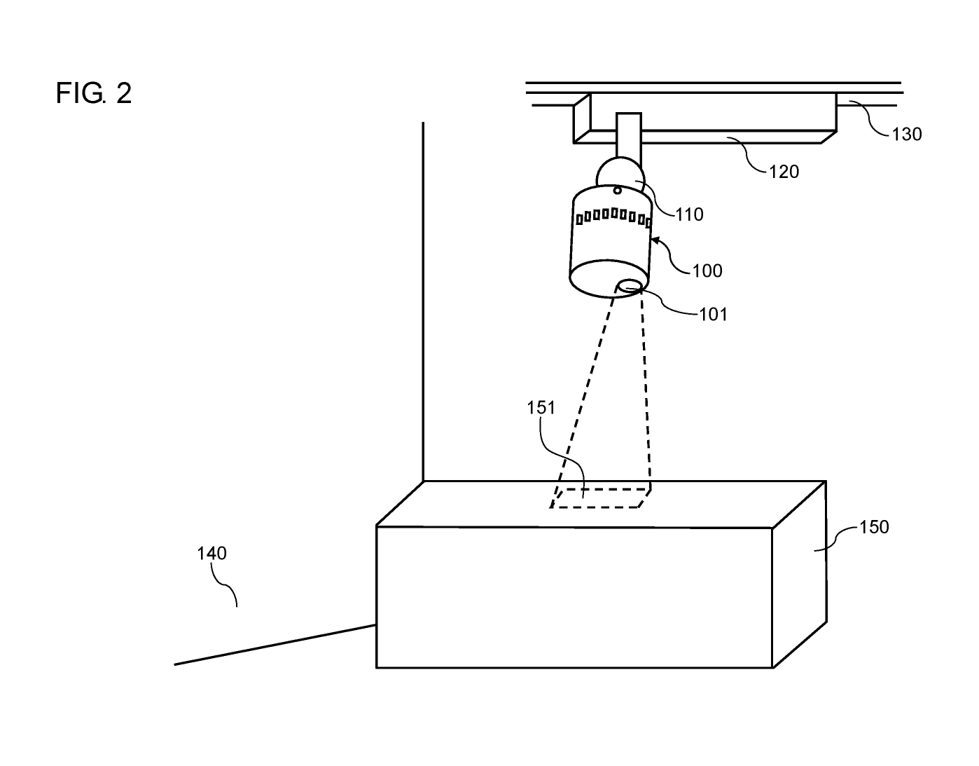

The outline of projection apparatus 100 will be described with reference to FIGS. 1 and 2.

FIG. 1 is a view illustrating a state in which projection apparatus 100 projects an image onto wall 140. FIG. 2 is a view illustrating a state in which projection apparatus 100 projects an image onto table 150.

As illustrated in FIGS. 1 and 2, projection apparatus 100 is fixed to housing 120 together with driver 110. Wiring lines electrically connected to components composing projection apparatus 100 and driver 110 are connected to a power source through housing 120 and wiring duct 130. With this, power is supplied to projection apparatus 100 and driver 110. Projection apparatus 100 has opening 101. Projection apparatus 100 projects an image through opening 101.

Driver 110 can drive projection apparatus 100 so as to change a projection direction of projection apparatus 100. As illustrated in FIG. 1, driver 110 can drive projection apparatus 100 so that the projection direction of projection apparatus 100 is toward wall 140. Thus, projection apparatus 100 can project image 141 onto wall 140. Similarly, driver 110 can drive projection apparatus 100 so that the projection direction of projection apparatus 100 is toward table 150 as illustrated in FIG. 2. Thus, projection apparatus 100 can project image 151 onto table 150. Driver 110 may be driven on the basis of a manual operation of a user, or may automatically be driven in response to a detection result of a predetermined sensor. Further, image 141 projected on wall 140 and image 151 projected on table 150 may be different from each other or may be the same.

The configuration and operation of projection apparatus 100 will be described below in detail.

[1. Configuration]

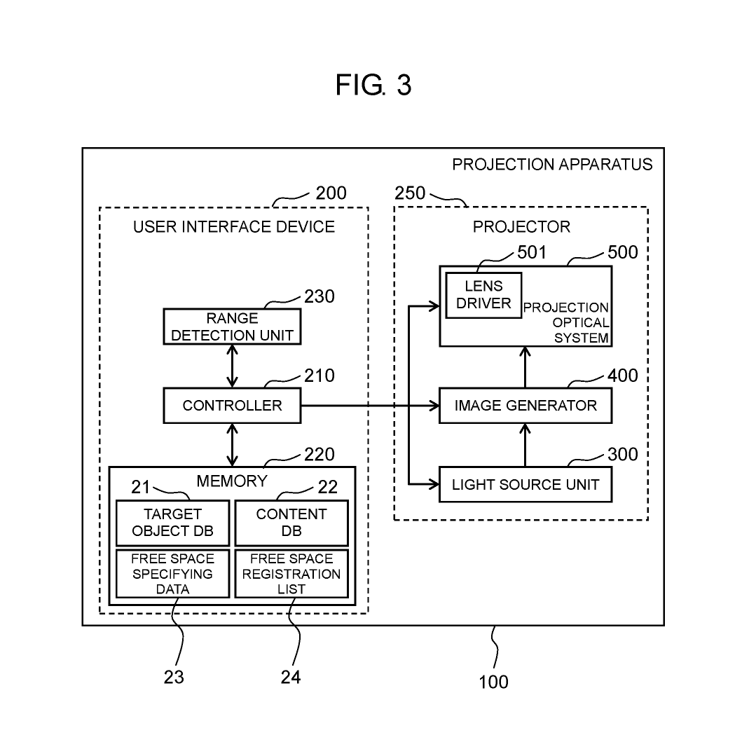

FIG. 3 is a block diagram illustrating the electric configuration of projection apparatus 100. Projection apparatus 100 includes user interface device 200 and projector 250. The configuration of each component composing projection apparatus 100 will be sequentially described below.

User interface device 200 includes controller 210, memory 220, and range detection unit 230. Projector 250 includes light source unit 300, image generator 400, and projection optical system 500.

Controller 210 is a semiconductor element that entirely controls projection apparatus 100. Specifically, controller 210 controls the operation of range detection unit 230, memory 220, light source unit 300, image generator 400, and projection optical system 500. Controller 210 can also perform a digital zoom control for zooming out and zooming in a projection image with an image signal process. Controller 210 may be composed only of hardware, or may be implemented by combining hardware and software.

Memory 220 is a memory element that stores various pieces of information. Memory 220 is one example of a storage unit in projection apparatus 100. Memory 220 is composed of a flash memory or a ferroelectric memory. Memory 220 stores a control program and the like for controlling projection apparatus 100 (including user interface device 200). Memory 220 also stores various data supplied from controller 210. Memory 220 also stores set data of a projection size with which a projection image is expected to be displayed, and data such as a table of focusing value according to information about the distance to a projection target. Various data stored in memory 220 will be described later.

Range detection unit 230 includes a TOF (Time-of-Flight) sensor. Range detection unit 230 detects the distance between itself and a surface facing range detection unit 230 with the TOF sensor. Range detection unit 230 is one example of a detector in projection apparatus 100. When facing wall 140 (see FIG. 1), range detection unit 230 detects the distance between itself and wall 140. Similarly, when facing table 150 (see FIG. 2), range detection unit 230 detects the distance between itself and table 150.

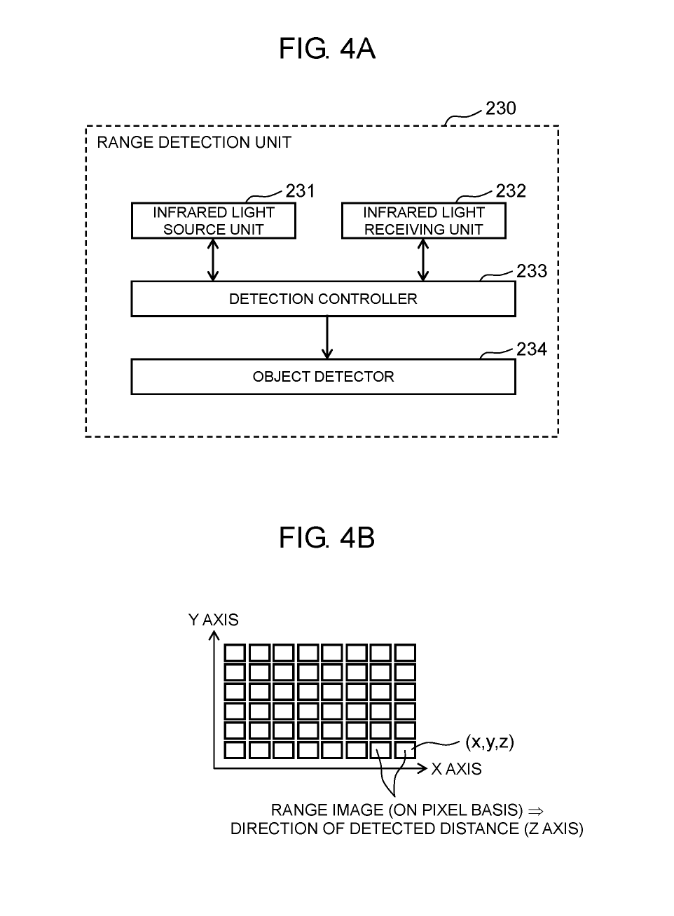

FIG. 4A is a block diagram illustrating the electric configuration of range detection unit 230. As illustrated in FIG. 4A, range detection unit 230 includes infrared light source unit 231 that emits infrared detection light, infrared light receiving unit 232 that receives infrared detection light reflected on an opposed surface, detection controller 233 that controls the infrared light source unit 231 and infrared light receiving unit 232, and object detector 234. Infrared light source unit 231, infrared light receiving unit 232, and detection controller 233 correspond to the TOF sensor. Object detector 234 is a semiconductor element, for example. Infrared light source unit 231 emits infrared detection light through opening 101 (see FIG. 1) such that the infrared detection light is diffused all around. Infrared light source unit 231 emits infrared light with a wavelength of 850 nm to 950 nm as infrared detection light, for example. Detection controller 233 stores the phase of the infrared detection light emitted from infrared light source unit 231 in memory 220. In the case where the surface facing range detection unit 230 has a tilt or shape, a plurality of pixels arrayed on a light-receiving surface of infrared light receiving unit 232 receives reflected infrared detection light at different timings. Since the plurality of pixels receives infrared detection light at different timings, the phases of the infrared detection light received by the respective pixels are different from one another. Detection controller 233 stores the phase of the infrared detection light received by each pixel of infrared light receiving unit 232 in memory 220.

Detection controller 233 acquires the phase of the infrared detection light emitted from infrared light source unit 231 and the phase of the infrared detection light received by each pixel in infrared light receiving unit 232 from memory 220. Thus, detection controller 233 is able to detect the distance between range detection unit 230 and the surface facing the range detection unit 230 on the basis of the phase difference between the infrared detection light emitted from infrared light source unit 231 and the infrared detection light received by the infrared light receiving unit 232. Object detector 234 detects an object on the basis of the distance detected by detection controller 233 as described later. Range detection unit 230 thus configured generates a range image on the basis of the detected distance.

FIG. 4B is a diagram for describing the range image generated by range detection unit 230. Range detection unit 230 detects a distance for each of the pixels composing infrared light receiving unit 232. With this, range detection unit 230 can detect the distance in the entire angle of view of infrared light receiving unit 232 on a pixel basis. In the description below, the horizontal direction of the range image is defined as an X axis, and the vertical direction is defined as a Y axis, as illustrated in FIG. 4B. The direction of the detected distance is defined as a Z axis. Controller 210 can acquire coordinates (x, y, z) of three axes of XYZ for each pixel composing the range image on the basis of the range image generated by range detection unit 230. Specifically, controller 210 can acquire a distance value on the basis of the detection result of range detection unit 230.

A TOF sensor is used as range detection unit 230 in the above. However, the present disclosure is not limited thereto. Specifically, range detection unit 230 may be the one that projects a known pattern such as a random dot pattern and calculates distance using the deviation from the pattern, or may be the one that uses disparity with a stereo camera to detect distance.

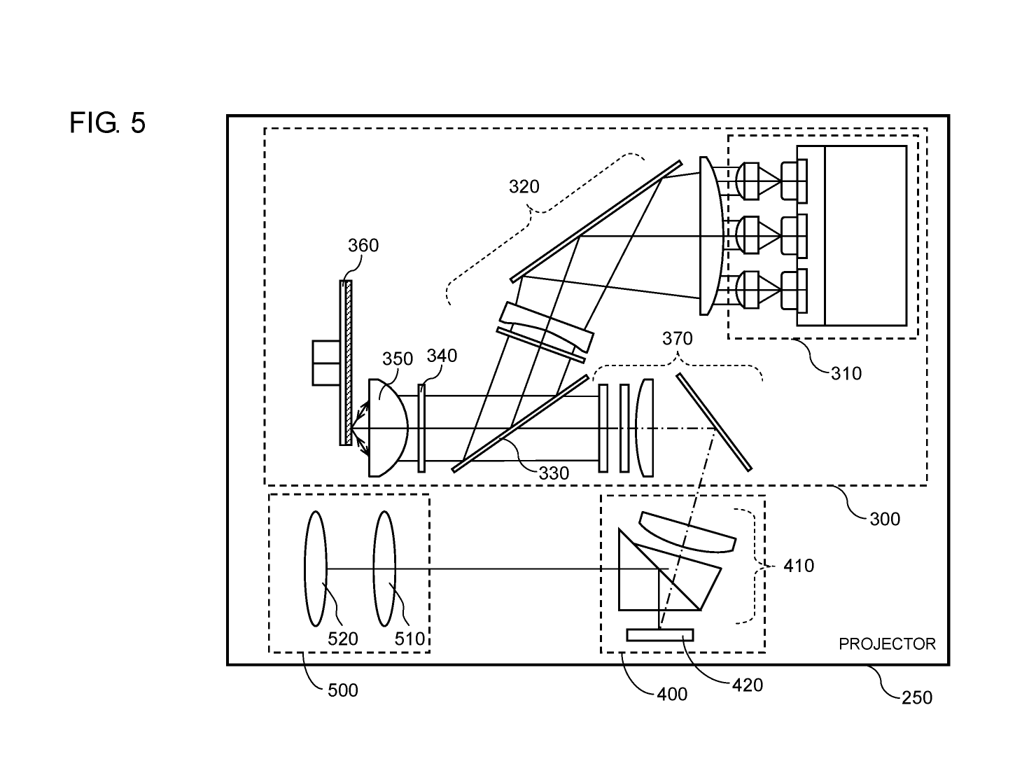

Next, the configuration of light source unit 300, image generator 400, and projection optical system 500 will be described with reference to FIG. 5. FIG. 5 is a block diagram illustrating the optical configuration of projector 250. As illustrated in FIG. 5, light source unit 300 supplies light to image generator 400. Image generator 400 generates a projection image from the supplied light, and supplies the generated projection image to projection optical system 500. Projection optical system 500 performs optical conversion, such as focusing and zooming, to the projection image supplied from image generator 400. Projection optical system 500 faces opening 101 (see FIG. 1), and projects the projection image through opening 101.

The configuration of light source unit 300 will firstly be described. As illustrated in FIG. 5, light source unit 300 includes semiconductor laser 310, dichroic mirror 330, λ/4 plate 340, phosphor wheel 360, and the like.

Semiconductor laser 310 is a solid light source that emits S-polarized blue light with wavelength of 440 nm to 455 nm, for example. S-polarized blue light emitted from semiconductor laser 310 is incident on dichroic mirror 330 through light guide optical system 320.

For example, dichroic mirror 330 is an optical element having high reflectance of 98% or more for S-polarized blue light with wavelength of 440 nm to 455 nm. On the other hand, dichroic mirror 330 has high transmittance of 95% or more for P-polarized blue light with wavelength of 440 nm to 455 nm and light (green light to red light) with wavelength of 490 nm to 700 nm regardless of polarization state. Dichroic mirror 330 reflects S-polarized blue light emitted from semiconductor laser 310 toward λ/4 plate 340.

λ/4 plate 340 is a polarization element that converts linear polarized light into circular polarized light or converts circular polarized light into linear polarized light. λ/4 plate 340 is disposed between dichroic mirror 330 and phosphor wheel 360. S-polarized blue light incident on λ/4 plate 340 is converted into circular polarized blue light, and then, incident on phosphor wheel 360 through lens 350.

Phosphor wheel 360 is a flat plate made of aluminum or the like and configured to be rotatable at high speed. Phosphor wheel 360 has, on its surface, a plurality of B regions that is a region of a diffusion reflection plane, a plurality of G regions on which a phosphor emitting green light is applied, and a plurality of R regions on which a phosphor emitting red light is applied. The circular polarized blue light incident on the B regions on phosphor wheel 360 is diffusely reflected, and again enters λ/4 plate 340 as circular polarized blue light. The circular polarized blue light incident on λ/4 plate 340 is converted into P-polarized blue light, and then, again enters dichroic mirror 330. The blue light incident on dichroic mirror 330 is P-polarized light. Therefore, this blue light passes through dichroic mirror 330, and enters image generator 400 through light guide optical system 370.

The blue light incident on the G regions on phosphor wheel 360 excites the phosphor applied on the G regions to allow the phosphor to emit green light. The green light emitted from the G regions enters dichroic mirror 330. The green light incident on dichroic mirror 330 passes through dichroic mirror 330, and enters image generator 400 through light guide optical system 370. Similarly, the blue light incident on the R regions on phosphor wheel 360 excites the phosphor applied on the R regions to allow the phosphor to emit red light. The red light emitted from the R regions enters dichroic mirror 330. The red light incident on dichroic mirror 330 passes through dichroic mirror 330, and enters image generator 400 through light guide optical system 370.

Due to the high-speed rotation of phosphor wheel 360, blue light, green light, and red light are time divided and emitted from light source unit 300 to image generator 400.

Image generator 400 generates a projection image according to an image signal supplied from controller 210. Image generator 400 includes DMD (Digital-Mirror-Device) 420, and the like. DMD 420 is a display element on which a lot of micromirrors are arrayed on a flat plane. DMD 420 deflects each of the arrayed mircomirrors according to the image signal supplied from controller 210. Thus, DMD 420 spatially modulates the incident light. Light source unit 300 emits blue light, green light, and red light in a time-division way. DMD 420 repeatedly and sequentially receives blue light, green light, and red light which are time divided and emitted through light guide optical system 410. DMD 420 deflects each of the micromirrors in synchronization with the timing at which light of each color is emitted from light source unit 300. With this, image generator 400 generates a projection image according to the image signal. DMD 420 deflects the micromirros to cause a part of light to be directed to projection optical system 500 and to cause the remaining light to be directed outside an effective range of projection optical system 500, according to the image signal. With this, image generator 400 can supply the generated projection image to projection optical system 500.

Projection optical system 500 includes optical members such as zoom lens 510 and focusing lens 520, and lens driver 501 (see FIG. 3) that drives the optical members. Lens driver 501 is composed of a motor, for example. Projection optical system 500 enlarges light directed from image generator 400 and projects the resultant light on a projection surface. Controller 210 controls lens driver 501, thereby being capable of controlling the position of zoom lens 510. Thus, controller 210 can control such that the projection image has a size of a desired zoom value. To increase the zoom value, controller 210 moves the zoom lens 510 in the direction in which the angle of view is reduced (in the tele direction) to reduce the projection image. On the other hand, to decrease the zoom value, controller 210 moves the zoom lens 510 in the direction in which the angle of view is increased (in the wide direction) to enlarge the projection image. In addition, controller 210 adjusts the position of focusing lens 520 on the basis of predetermined zoom tracking data so as to track the movement of zoom lens 510. Thus, controller 210 can perform focusing of a projection image. In this way, projector 250 projects a projection image on a predetermined projection surface.

In the above description, the configuration of DLP (Digital-Light-Processing) system using DMD 420 is used as one example of projection apparatus 100. However, the present disclosure is not limited thereto. That is, a configuration using a liquid crystal system may be applied to projection apparatus 100.

The configuration using a single-chip system in which light is time divided using phosphor wheel 360 has been described above as one example of projection apparatus 100. However, the present disclosure is not limited thereto. That is, for projection apparatus 100, the configuration using three-light-source system provided with light sources of blue light, green light, and red light may be used, or a three-chip configuration provided with a DMD for each color of RGB may be used.

The configuration in which semiconductor laser 310 emitting blue light and infrared light source unit 231 emitting infrared detection light are different units has been described above. However, the present disclosure is not limited thereto. That is, a unit formed by combining semiconductor laser 310 and infrared light source unit 231 may be used. If a three-light-source system is employed, a unit formed by combining light sources of respective colors and infrared light source unit 231 may be used.

[1-1. With Respect to Various Data]

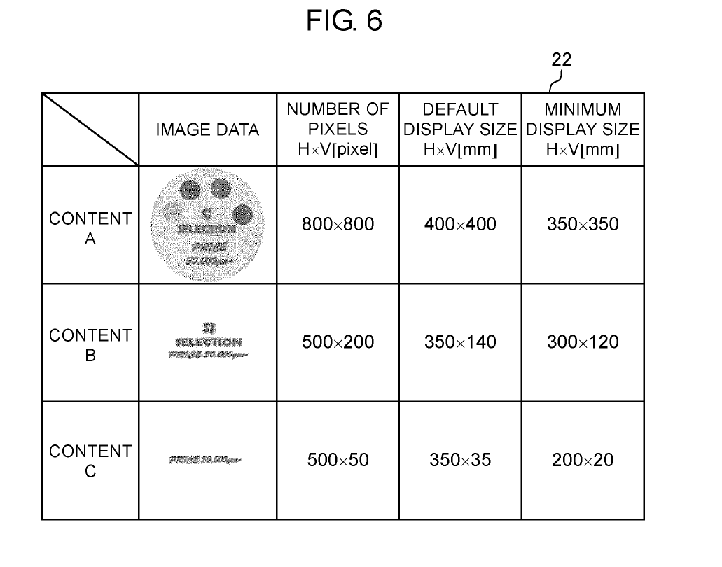

Various data stored in memory 220 will be described below with reference to FIGS. 3 and 6. FIG. 6 is a diagram for describing a content database (the database is hereinafter abbreviated to “DB”).

As illustrated in FIG. 3, memory 220 stores target object DB 21, content DB 22, free space specifying data 23, free space registration list 24, and the like. Target object DB 21 is a database for recording data of various shapes indicating a three-dimensional shape of a target object of which information is to be presented.

Content DB 22 is a database for recording information presented by a projection image for each target object. FIG. 6 illustrates one example of content DB 22. In content DB 22 illustrated in FIG. 6, “image data”, a “number of pixels”, a “default display size”, and a “minimum display size” are recorded in association with each of contents A, B, and C.

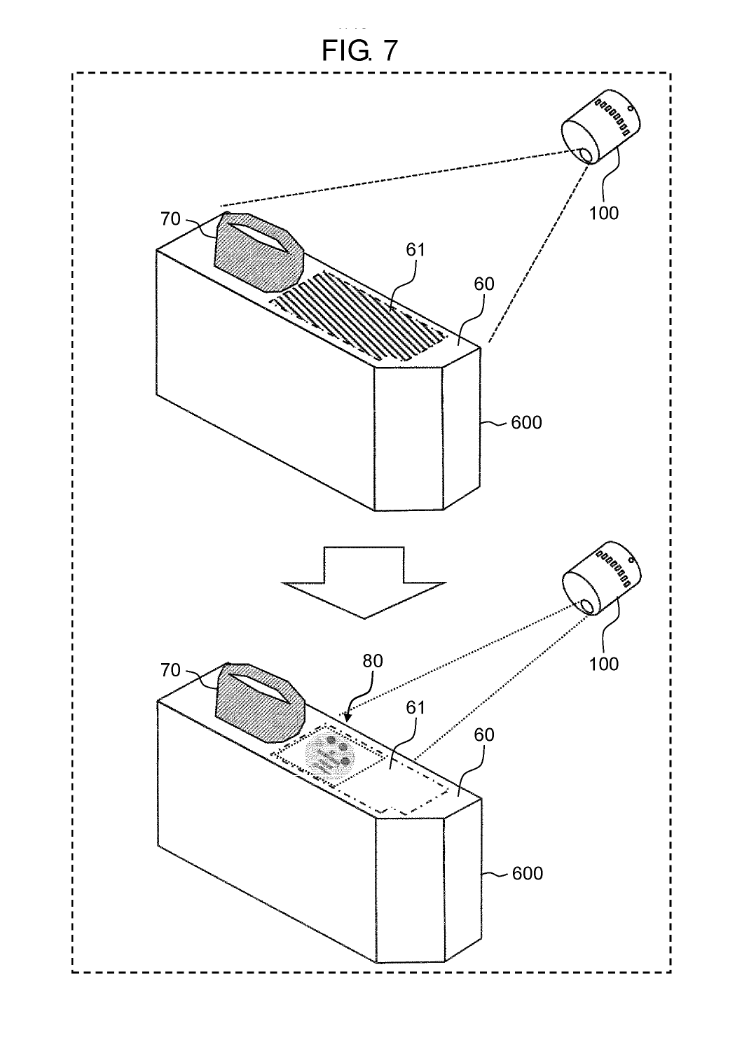

In FIG. 6, each of contents A, B, and C has information concerning specific target object 70 (see FIG. 7). The order of contents A, B, and C recorded in content DB 22 indicates the priority order in which the image data associated with each of contents A, B, and C is projected as content. As illustrated in FIG. 6, the image data of content A includes text information of graphics, logo, price, and the like. The image data of content B includes text information of logo, price, and the like. The image data of content C includes text information of price, and the like.

In FIG. 6, the “number of pixels” is the number of pixels of the image data recorded in association with each of contents A, B, and C. The “default display size” is a standard display size when the image data of each of contents A, B, and C is displayed on a projection surface as content. The “minimum display size” is the minimum display size when the image data of each of contents A, B, and C is displayed on a projection surface as content. The number of pixels, the default display size, and the minimum display size are respectively defined by a horizontal size and a vertical size of a rectangular region. For example, it is recorded that the default display size of content A is 400 mm in the horizontal size and 400 mm in the vertical size in content DB 22 in FIG. 6.

FIG. 6 illustrates the data associated with specific target object 70 (see FIG. 7) in content DB 22. In content DB 22, a plurality of contents illustrated in FIG. 6 are recorded in association with each of a plurality of target objects.

Free space specifying data 23 (see FIG. 3) is data indicating the result of specifying a free space specified for projecting content by projection apparatus 100 according to the present exemplary embodiment. Free space registration list 24 is a list including free spaces that are the candidates on which content is to be projected.

[2. Operation]

The operation of projection apparatus 100 according to the present exemplary embodiment will be described below.

[2-1. Outline of Operation]

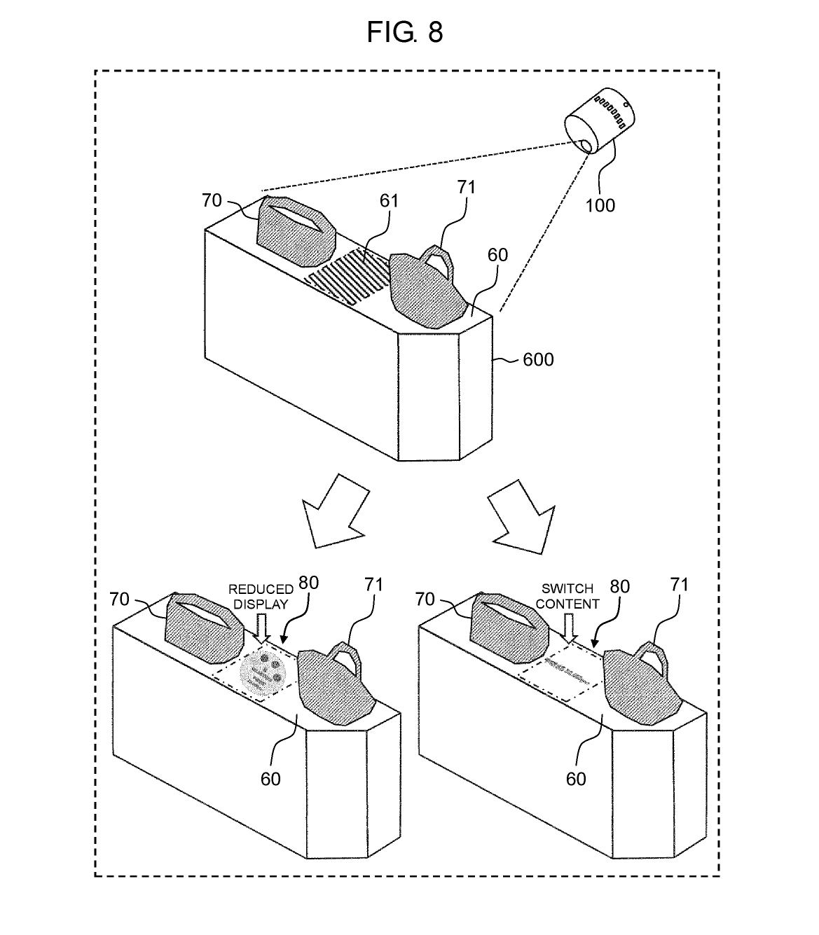

The outline of the operation of projection apparatus 100 according to the present exemplary embodiment will be described with reference to FIGS. 7 and 8. FIG. 7 is a view for describing a projection operation by projection apparatus 100. FIG. 8 is a view for describing a projection operation of projection apparatus 100 when object 71 other than target object 70 is placed.

Projection apparatus 100 according to the present exemplary embodiment projects projection image 80 on shelf surface 60 of store shelf 600 in the state in which target object 70 such as a specific commodity is displayed on store shelf 600, for example (see FIG. 7). A user such as a shop staff can present information concerning target object 70 to a customer or the like using the content included in projection image 80. If the content in projection image 80 is projected on an object such as target object 70 when the user places target object 70 on shelf surface 60 of store shelf 600 in a desired layout, the display of the content is distorted. Therefore, it becomes hard for a viewer such as a customer to see the content.

In view of this, projection apparatus 100 according to the present exemplary embodiment detects an object (an obstacle on the projection surface) including target object 70 on shelf surface 60, which is the projection surface, using range detection unit 230 (see FIG. 3) as illustrated in FIG. 7. Projection apparatus 100 also specifies free space 61 which is free without overlapping an object. Then, as illustrated in FIG. 7, projection apparatus 100 projects content near target object 70 within the range of free space 61. This makes it easy for a viewer to see the content in projection image 80.

As illustrated in FIG. 8, object 71 other than target object 70, such as a commodity which is not the subject of which information is to be presented, may be placed on store shelf 600. When other object 71 is placed along with target object 70, or the arrangement of objects 70 and 71 is changed, on store shelf 600, free space 61 on shelf surface 60 may be decreased or content may be outside free space 61.

In view of this, projection apparatus 100 according to the present exemplary embodiment reduces the content in projection image 80 and displays the reduced content or the content to be projected is switched, according to specified free space 61. Thus, projection apparatus 100 can automatically project projection image 80 by effectively using free space 61 on shelf surface 60 without requiring special setting by a user. The detail of the operation of projection apparatus 100 according to the present exemplary embodiment will be described below.

[2-2. Detail of Operation]

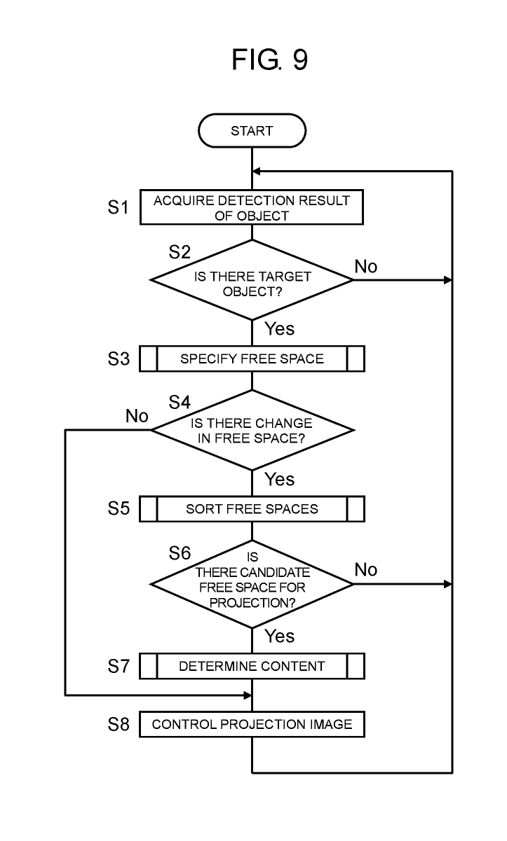

The projection operation by projection apparatus 100 according to the present exemplary embodiment will be described with reference to FIG. 9. FIG. 9 is a flowchart for describing the projection operation by projection apparatus 100.

Each process in the flowchart in FIG. 9 is executed by controller 210 (see FIG. 3) in projection apparatus 100. The process in this flowchart is started in the state in which objects 70 and 71 including target object 70 are placed on shelf surface 60 as illustrated in FIG. 8, and repeatedly executed in a predetermined cycle (for example, 1/30 second).

Firstly, controller 210 acquires the detection result of object 70 and object 71 within the detection range of range detection unit 230 (S1). In the present exemplary embodiment, the detection range of range detection unit 230 is set to shelf surface 60 of store shelf 600.

In step S1, range detection unit 230 acquires a distance value of each pixel of a range image on shelf surface 60 on which object 70 and object 71 are placed. Then, range detection unit 230 detects object 70 and object 71 placed on shelf surface 60 on the basis of the acquired distance value of each pixel. Range detection unit 230 detects an object using a difference between the preliminarily acquired distance value of each pixel in a range image on shelf surface 60 and the acquired distance value of each pixel. Range detection unit 230 may detect an object placed on shelf surface 60 using the equation of a plane of shelf surface 60 calculated beforehand. Specifically, range detection unit 230 may detect an object using any method by which the object placed on shelf surface 60 is detectable. A region where object 70 or object 71 overlap the detection range (shelf surface 60) on a range image is referred to as an “object region” below.

Next, controller 210 determines whether or not there is target object 70 among object 70 and object 71, which have been detected, on the basis of the range image acquired from range detection unit 230 (S2). Controller 210 compares the shape data recorded in target object DB 21 and the three-dimensional shape indicated by the object region on the range image by referring to target object DB 21 (see FIG. 3) stored in memory 220, for example. Thus, controller 210 specifies target object 70 included among object 70 and object 71.

When determining that there is no target object 70 among object 70 and object 71 which have been detected (No in S2), controller 210 repeats the process in step S1 in a predetermined cycle (for example, 1/30 second).

On the other hand, when determining that there is target object 70 among object 70 and object 71 which have been detected (Yes in S2), controller 210 specifies free space 61 on shelf surface 60 within the detection range on the basis of the detection result of range detection unit 230 (S3). In the present exemplary embodiment, when there is a plurality of free spaces on which content can be projected on different locations on shelf surface 60, controller 210 specifies free space 61 according to each location. In step S3, free space specifying data 23 indicating the specifying result of free space 61 is generated. The detail of the process for specifying free space 61 in step S3 will be described later.

Next, controller 210 detects whether or not there is a change in free space 61 on the basis of the specifying result of free space 61 (S4). For example, controller 210 detects the change in free space 61 on shelf surface 60 by comparing free space specifying data 23 generated in step S3 and free space specifying data 23 in the previous cycle.

When detecting the change in free space 61 (Yes in S4), controller 210 sorts one or more free spaces 61 included in free space specifying data 23 (S5). For example, controller 210 registers free space 61 located within a predetermined upper distance to free space registration list 24 stored in memory 220 according to the distance between target object 70 and free space 61. Free space registration list 24 is a list in which candidate free spaces on which content concerning target object 70 is to be projected are registered in ascending order of distance from target object 70. The detail of the process for sorting free spaces 61 in step S5 will be described later.

Next, controller 210 determines whether or not there is a candidate free space for projection on the basis of free space registration list 24 (S6). When determining that there is no candidate free space for projection (No in S6), controller 210 returns to the process in step S1.

On the other hand, when determining that there is candidate free space 61 for projection (Yes in S6), controller 210 determines the type and display size of the content in projection image 80 according to candidate free space 61 for projection by referring to content DB 22 (see FIG. 6) (S7). The detail of the process for determining content in step S7 will be described later.

Next, controller 210 controls projection image 80 such that the determined content is projected within the range of free space 61 by projector 250 (S8). Controller 210 generates an image signal indicating the content of the type and the display size determined in step S7, and outputs the generated image signal to image generator 400 in projector 250. In addition, controller 210 adjusts the zoom value and the focusing value such that projection image 80 is projected on shelf surface 60 serving as the projection surface by controlling projection optical system 500 in projector 250. In this way, controller 210 controls projection image 80.

In step S8, controller 210 may cause projector 250 to project projection image 80 by maintaining the zoom value and the focusing value used in the previous cycle. In this case, controller 210 may adjust the position and display size of projection image 80 in an image signal process.

In addition, when not detecting the change in free space 61 on the basis of the specifying result of free space 61 in step S3 (No in S4), controller 210 causes projector 250 to project projection image 80 similar to that in the previous cycle (S8).

After the process in step S8, controller 210 repeats the process in step S1 and the subsequent steps in a predetermined cycle.

According to the process described above, projection apparatus 100 specifies target object 70 and free space 61 near target object 70. Then, projection apparatus 100 can project the content concerning target object 70 within the range of free space 61 by projecting projection image 80. The processes in steps S3, S5, and S7 in the flowchart in FIG. 9 will be described in detail below.

(1) Process in Step S3

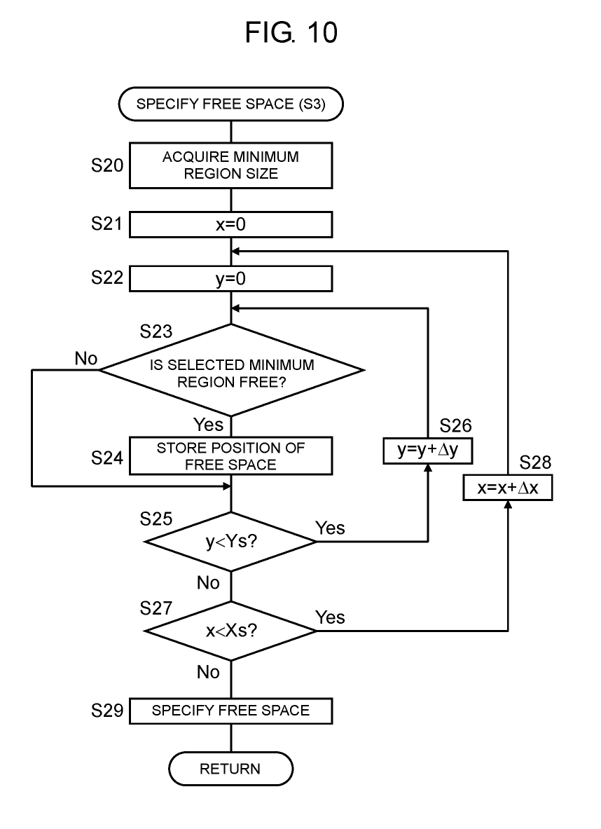

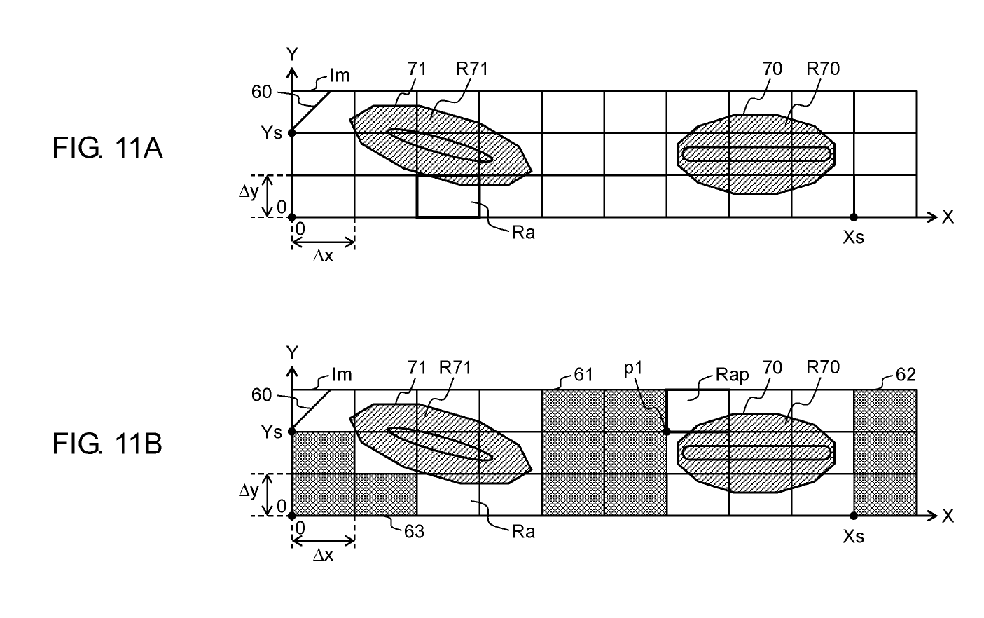

The process for specifying a free space in step S3 in the flowchart in FIG. 9 will be described with reference to FIGS. 10, 11A, and 11B. FIG. 10 is a flowchart illustrating the process (S3) for specifying a free space by projection apparatus 100.

In the process in FIG. 10, controller 210 specifies a free space on the basis of the range image acquired from range detection unit 230 in step S1 in FIG. 9. FIG. 11A illustrates range image Im acquired from range detection unit 230. As illustrated in FIG. 11A, controller 210 defines minimum region Ra in order to specify a free space on range image Im within the detection range of an object. Controller 210 specifies a free space excluding a region smaller than minimum region Ra. Hereinafter, the horizontal direction is defined as an X direction, and the vertical direction is defined as a Y direction in range image Im as illustrated in FIG. 11A.

In the flowchart in FIG. 10, controller 210 firstly acquires a minimum region size which is the size for defining minimum region Ra (S20). The minimum region size is stored beforehand in memory 220 as a horizontal size and a vertical size indicating a rectangular region on an actual projection surface, for example. For example, the minimum region size is defined as the smallest horizontal size and vertical size out of the minimum display sizes for all target objects recorded in content DB 22.

In step S20, controller 210 acquires the minimum region size from memory 220, and calculates horizontal size Δx and vertical size Δy which indicate the minimum region size on range image Im (see FIG. 11A). For example, controller 210 uniformly calculates horizontal size Δx and vertical size Δy in range image Im on the basis of the average of distance values of the respective pixels in the region except for object region R70 overlapping object 70 and object region R71 overlapping object 71 in range image Im.

Next, controller 210 selects x=0 as an X coordinate (S21) and y=0 as a Y coordinate (S22) on range image Im as illustrated in FIG. 11A. The origin of the coordinate is set, as appropriate, as a starting point at which specifying a free space on range image Im is started.

Then, controller 210 determines whether or not minimum region Ra based on the selected coordinate (x, y) is free without overlapping object 70 or object 71 (S23). In the present exemplary embodiment, minimum region Ra in step S23 is a rectangular region, on range image Im, having four points (x, y), (x+Δx, y), (x, y+Δy), and (x+Δx, y+Δy) based on the coordinate (x, y) selected by controller 210 as vertices. For example, controller 210 determines whether or not there is object region R70 or object region R71 in minimum region Ra by comparing the distance value of each pixel in minimum region Ra to a predetermined threshold. Alternatively, controller 210 may determine whether or not there is object region R70 or object region R71 in minimum region Ra on the basis of the variation in the distribution of distance values in minimum region Ra.

When determining that minimum region Ra based on the selected coordinate (x, y) is free without overlapping object 70 or object 71 (Yes in S23), controller 210 stores the position of minimum region Ra which has been determined to be free into memory 220 as the position where a free space is specified (S24). For example, in the example in FIG. 11A, minimum region Ra based on the coordinate of (x,=(0, 0) does not overlap object region R70 or object region R71. Therefore, the position of {(0, 0), (Δx, 0), (0, Δy), (Δx, Δy)} of minimum region Ra is stored in memory 220 in step S24.

On the other hand, when determining that minimum region Ra based on the selected coordinate (x, y) is not free (No in S23), controller 210 proceeds to step S25 without storing the position of minimum region Ra into memory 220.

Next, controller 210 determines whether or not the selected y is less than upper limit value Ys (S25). Upper limit value Ys is set based on the border of the detection range in the Y direction in range image Im. In the present exemplary embodiment, upper limit value Ys is set to be a value smaller than the maximum value of shelf surface 60 in range image Im in the Y direction by vertical size Δy, as illustrated in FIG. 11A. In the case where selected y is smaller than Ys (Yes in S25), controller 210 newly selects y+Δy which is the Y coordinate larger by vertical size Δy of minimum region Ra (S26), and repeats the processes in step S23 and the subsequent steps. Thus, controller 210 sequentially scans shelf surface 60 in the Y direction to specify a free space of the minimum region size.

When selected y becomes equal to or larger than Ys (No in S25), controller 210 determines whether or not selected x is less than upper limit value Xs (S27). Upper limit value Xs is set based on the border of the detection range in the X direction in range image Im. In the present exemplary embodiment, upper limit value Xs is set to be a value smaller than the maximum value of shelf surface 60 in range image Im in the X direction by horizontal size Δx, as illustrated in FIG. 11A.

In the case where selected x is smaller than Xs (Yes in S27), controller 210 newly selects x+Δx which is the X coordinate larger by horizontal size Δx of minimum region Ra (S28), and repeats the processes in step S22 and the subsequent steps. Thus, specifying a free space of the minimum region size is performed throughout the entire detection range with the X direction being defined as a sub-scanning direction and the Y direction being defined as a main scanning direction.

When selected x becomes equal to or larger than Xs (No in S27), controller 210 specifies a free space on the basis of the positions of minimum regions Ra stored in memory 220 (S29). Controller 210 specifies the region where the positions of the plurality of minimum regions Ra stored in memory 220 are connected to one another as one free space. Controller 210 also specifies the plurality of regions where the positions of the plurality of minimum regions Ra stored in memory 220 are separated as a plurality of free spaces. Thus, controller 210 specifies one or more free spaces. For example, in range image Im illustrated in FIG. 11A, controller 210 specifies three free spaces 61, 62, and 63 as illustrated in FIG. 11B. Controller 210 generates free space specifying data 23 (see FIG. 3) indicating a group of free spaces 61, 62, and 63 as the specifying result.

Controller 210 generates free space specifying data 23, ends the process in step S3 in the flowchart in FIG. 9, and then, proceeds to step S4.

According to the above process, controller 210 can specify a group of free spaces 61, 62, and 63 not overlapping object region R70 by target object 70 or object region R71 by other object 71 on shelf surface 60 which is the detection range, using range image Im generated by range detection unit 230.

FIG. 11B illustrates the specifying result of a free space based on range image Im in FIG. 11A. As illustrated in FIG. 11B, minimum region Rap based on coordinate pl in range image Im partly overlaps object region R70. In the present exemplary embodiment, controller 210 excludes the minimum region overlapping the object region, such as minimum region Rap (No in S23). Thus, controller 210 can specify each of a plurality of free spaces 61, 62, and 63.

(2) Process in Step S5

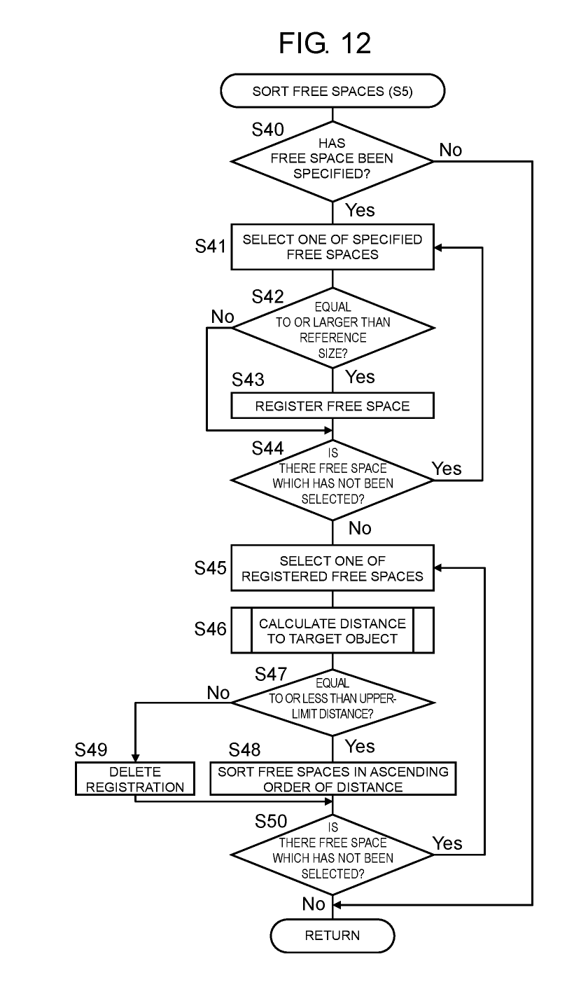

The process for sorting free spaces in step S5 in the flowchart in FIG. 9 will be described with reference to FIG. 12. FIG. 12 is a flowchart illustrating the process (S5) for sorting free spaces by projection apparatus 100.

Firstly, controller 210 determines whether or not a free spaces is specified on the basis of the specifying result in step S3 in FIG. 9 (S40). For example, in the example in FIG. 11B, free space specifying data 23 indicating a group of free spaces 61, 62, and 63 is generated, and controller 210 proceeds to “Yes” in step S40.

When determining that a free space is specified (Yes in S40), controller 210 selects one free space out of a group of free spaces 61, 62, and 63 indicated by free space specifying data 23 (S41).

Next, controller 210 determines whether or not the size of the selected free space on the projection surface is equal to or larger than a predetermined reference size (S42). For example, the reference size is set to the smallest size out of the minimum display sizes recorded in content DB 22 concerning target object 70 specified in step S2 in FIG. 9.

In step S42, controller 210 sets the maximum rectangular region within the range of the selected free space on the basis of range image Im, and calculates the size of the set rectangular region. The process in step S42 is performed using the size on the actual projection surface (shelf surface 60) as a reference. Controller 210 performs geometric correction or the like, as appropriate, in order that the rectangular region in the free space becomes rectangular on the actual projection surface.

When determining that the size of the selected free space is equal to or larger than the reference size (Yes in S42), controller 210 registers the selected free space in free space registration list 24 (see FIG. 3) stored in memory 220 (S43). Free space registration list 24 stores free spaces that are the candidates on which content is to be projected.

On the other hand, when determining that the size of the selected free space is less than the reference size (No in S42), controller 210 proceeds to step S44 without registering the selected free space to free space registration list 24. Thus, the region smaller than the reference size is excluded from the candidate free spaces on which content is to be projected.

Next, controller 210 determines whether or not there is a free space, which has not yet been selected in step S41, in free space specifying data 23 (S44). When there is a free space which has not yet been selected (Yes in S44), controller 210 repeats the processes in step S41 and the subsequent steps to the free space which has not been selected.

When there is no free space, which has not been selected, left in free space specifying data 23 (No in S44), controller 210 selects one free space out of the free spaces registered in free space registration list 24 (S45).

Next, controller 210 calculates the distance from the selected free space to target object 70 specified in step S2 in FIG. 9 (S46). In the present exemplary embodiment, to preferentially project content on the free space closest to target object 70 by projection apparatus 100, controller 210 defines the distance between each free space and target object 70, and calculates the distance between target object 70 and each of the candidate free spaces. The detail of the process for calculating the distance to target object 70 in step S46 will be described later.

Next, controller 210 determines whether or not the calculated distance is equal to or less than a predetermined upper-limit distance (S47). The upper-limit distance is set to project content within a predetermined range from target object 70, and set according to the size of target object 70, for example.

When the calculated distance is equal to or less than the upper-limit distance (Yes in S47), controller 210 sorts the selected free spaces in ascending order of distance in free space registration list 24 (S48). Thus, the free spaces which are the candidates for projection are sorted in ascending order of distance to target object 70 in free space registration list 24.

On the other hand, when the calculated distance is larger than the upper-limit distance (No in S47), controller 210 excludes the selected free space from free space registration list 24 (S49). Thus, on the basis of the upper-limit distance, a free space which is too far from target object 70 is excluded from the projection candidates that are the locations where the content concerning target object 70 is to be projected.

Next, controller 210 determines whether or not there is a free space, which has not been selected in step S45, in free space registration list 24 (S50). When there is a free space which has not yet been selected in free space registration list 24 (Yes in S50), controller 210 repeats the processes in step S45 and the subsequent steps to the free space which has not been selected.

When there is no free space, which has not been selected, left in free space registration list 24 (No in S50), controller 210 ends the process in step S5 in FIG. 9, and proceeds to step S6.

In addition, when determining that a free space is not specified on the basis of the specifying result in step S3 in FIG. 9 (No in S40), controller 210 ends the process in step S5 in FIG. 9 without performing the processes in step S41 and the subsequent steps. In this case, controller 210 proceeds to “No” in step S6 in FIG. 9 to again detect an object (S1).

According to the above process, in the case where a group of free spaces 61, 62, and 63 is specified within the detection range such as shelf surface 60, appropriate free spaces are sorted as candidate free spaces on which content is to be projected, on the basis of the size of each free space and the distance between each free space and target object 70.

(2-1) Process in Step S46

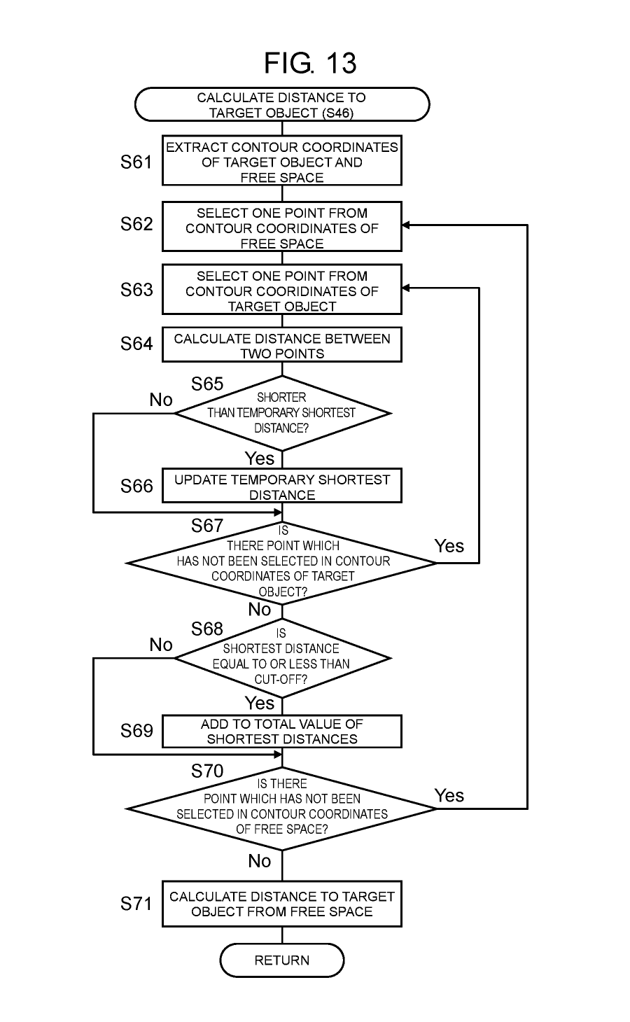

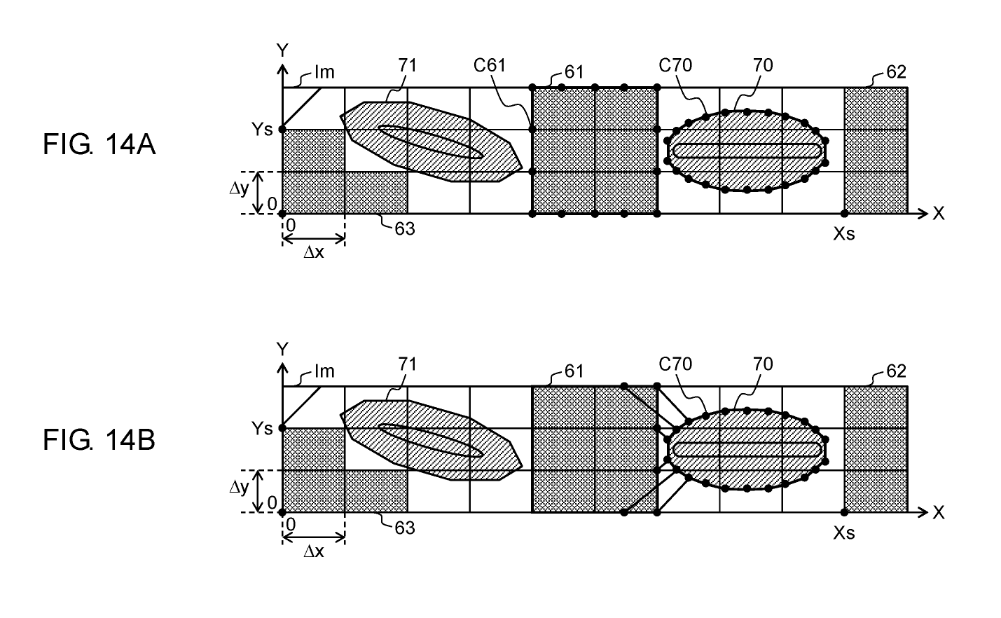

The process for calculating the distance to a target object in step S46 in the flowchart in FIG. 12 will be described with reference to FIGS. 13, 14A, and 14B. FIG. 13 is a flowchart illustrating the process (S46) for calculating the distance to a target object. FIGS. 14A and 14B are each a diagram for describing the process for calculating the distance to a target object.

This process is performed to target object 70 specified in step S2 in FIG. 9 and the free space selected in step S45 in FIG. 12. The example in which free space 61 is selected in step S45 will be described below as one example (see FIGS. 14A and 14B).

Firstly, controller 210 extracts a plurality of contour coordinates C70 of target object 70 and a plurality of contour coordinates C61 of free space 61 in range image Im as illustrated in FIG. 14A, for example (S61).

Next, controller 210 selects one of extracted contour coordinates C61 (S62). In the present exemplary embodiment, controller 210 calculates the distance to target object 70 from each point on contour coordinates C61. Therefore, controller 210 selects one point from contour coordinates C61 in step S62. For example, controller 210 selects one point from points with a predetermined space in the plurality of contour coordinates C61.

Next, controller 210 selects one point from the extracted contour coordinates C70 in order to calculate the shortest distance from selected contour coordinate C61 to target object 70 (S63). For example, controller 210 selects one point from points with a predetermined space in the plurality of contour coordinates C70.

Next, controller 210 calculates the distance between two points selected from contour coordinates C61 and contour coordinates C71 (S64). Controller 210 calculates the distance between the selected two points in the actual space on the basis of the coordinates of the selected points and the distance values of the pixels in range image Im.

Then, controller 210 determines whether or not the calculated distance between the two points is shorter than the temporary shortest distance stored in memory 220 (S65). Memory 220 may store a default value (e.g., a cut-off value described later) of the temporary shortest distance in advance.

When determining that the calculated distance between the two points is shorter than the temporary shortest distance (Yes in S65), controller 210 rewrites the temporary shortest distance stored in memory 220 to the calculated distance to update the temporary shortest distance (S66).

On the other hand, when determining that the calculated distance between the two points is not shorter than the temporary shortest distance (No in S65), controller 210 proceeds to step S67 without updating the temporary shortest distance.

Next, controller 210 determines whether or not there is a point, which has not been selected, in contour coordinates C70 (S67). When there is a point which has not yet been selected in contour coordinates C70 (Yes in S67), controller 210 repeats the processes in step S63 and the subsequent steps to the point which has not yet been selected. Thus, the shortest distance out of the distances between the selected point in contour coordinates C61 and each point in contour coordinates C70 can be obtained as the last updated temporary shortest distance.

Controller 210 repeats the processes in step S63 and the subsequent steps until there is no point, which has not been selected, left in contour coordinates C70 (No in S67), and then, determines whether or not the obtained shortest distance is equal to or less than a predetermined cut-off value (S68). The cut-off value is a value for excluding such effect that the shortest distance to target object 70, which distance is calculated when a point far from target object 70 is selected in contour coordinates C61 of free space 61, is increased according to the size of free space 61. The cut-off value is set to the maximum size out of the default display sizes in content DB 22 stored in memory 220, or other values.

When determining that the obtained shortest distance is equal to or less than the cut-off value (Yes in S68), controller 210 adds the obtained shortest distance to the total value of the shortest distances of the respective points in the plurality of contour coordinates C61 (S69). In addition, controller 210 adds 1 to the total number of times of addition.

On the other hand, when determining that the obtained shortest distance is larger than the cut-off value (No in S68), controller 210 proceeds to step S70 without adding the obtained shortest distance to the total value of the shortest distances.

Next, controller 210 determines whether or not there is a point, which has not yet been selected, in contour coordinates C61 (S70). When there is a point which has not yet been selected in contour coordinates C61 (Yes in S70), controller 210 repeats the processes in step S62 and the subsequent steps to the point which has not yet been selected in contour coordinates C61. Thus, the shortest distance from each point on contour coordinates C61 to target object 70 is calculated. In addition, the total value of the shortest distances is a total value of the shortest distances equal to or lower than the cut-off value in contour coordinates C61 (see FIG. 14B).

Controller 210 performs the process in step S62 and the subsequent steps until there is no point, which has not been selected, left in contour coordinates C61 (No in S70), and then, calculates the distance from free space 61 to target object 70 on the basis of the calculation result of step S69 (S71). Controller 210 calculates an average of the shortest distances equal to or lower than the cut-off value in contour coordinates C61 on the basis of the total value of the shortest distances obtained by the addition in step S69 and the total number of times of addition, as the distance from free space 61 to target object 70.

Thus, controller 210 ends the process in step S46 in FIG. 12, and then, proceeds to step S47.

According to the above process, controller 210 can calculate the distance indicating the closeness to target object 70 from free space 61 by using the average of the shortest distances from each contour coordinate C61 to target object 70 (S71). In addition, controller 210 calculates the average using only the shortest distances which are equal to or lower than the cut-off value (S68), and this prevents the distance from being calculated to be larger due to larger free space 61.

(3) Process in Step S7

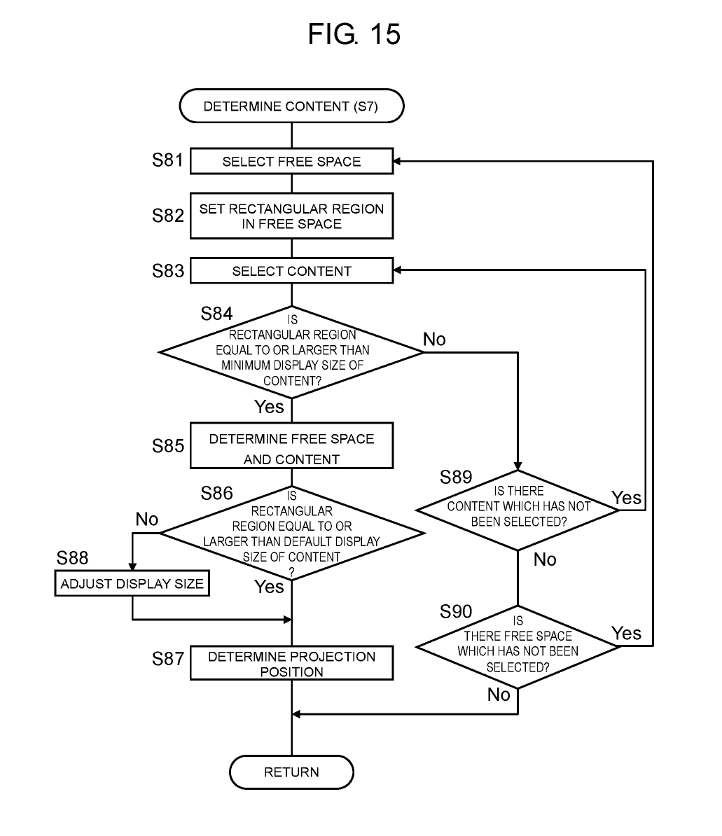

The process for determining content in step S7 in the flowchart in FIG. 9 will be described with reference to FIG. 15. FIG. 15 is a flowchart illustrating the process (S7) for determining content by projection apparatus 100.

Firstly, controller 210 selects one free space as the candidate on which content is to be projected from free space registration list 24 (S81). Controller 210 selects one free space from free space registration list 24 according to the registration order (S48 in FIG. 12).

Next, controller 210 sets a rectangular region in the free space on the basis of the contour coordinates of the selected free space in range image Im (S82). Controller 210 sets the maximum rectangular region in the selected free space by performing geometric correction or the like, as appropriate, in such a way that the rectangular region is oriented in a predetermined direction on the actual shelf surface 60. The predetermined direction is the direction, such as the direction in which the X direction of the rectangular region is along the border of shelf surface 60, by which the viewer is easy to see the rectangular region. The predetermined direction is stored in memory 220 beforehand in association with the detection range (shelf surface 60), for example.

Next, controller 210 selects one content associated with target object 70 from content DB 22 stored in memory 220 (S83). Controller 210 selects one content according to the order of the contents recorded in content DB 22 (see FIG. 6).

Then, controller 210 determines whether or not the size of the rectangular region in the free space which is the candidate for projection is equal to or larger than the minimum display size of the selected content by referring to content DB 22 (S84). Controller 210 calculates the horizontal size and the vertical size of the rectangular region on actual shelf surface 60 on the basis of the distance value of each pixel in the rectangular region in range image Im. In the case where the calculated horizontal size and the calculated vertical size of the rectangular region are equal to or larger than the horizontal size and the vertical size of the minimum display size, controller 210 proceeds to “Yes” in step S84, and in all other cases, proceeds to “No”.

When determining that the size of the rectangular region in the free space which is the candidate for projection is equal to or larger than the minimum display size of the selected content (Yes in S84), controller 210 determines that the selected content is to be projected in the free space which is selected as the candidate for projection (S85).

Next, controller 210 determines whether or not the size of the rectangular region set in the free space is equal to or larger than the default display size of the content to be projected by referring to content DB 22 (S86). In the case where the horizontal size and the vertical size of the rectangular region are equal to or larger than the horizontal size and the vertical size of the default display size, controller 210 proceeds to “Yes” in step S86, and in all other cases, proceeds to “No”.

When determining that the size of the rectangular region set in the free space is equal to or larger than the default display size of the content to be projected (Yes in S86), controller 210 determines the projection position of the content such that the content with the default display size comes closest to target object 70 in the free space (S87). At that time, controller 210 determines the projection position of the content such that the content is adjacent to the side closest to target object 70 out of the sides of the rectangular region. Thus, controller 210 can cause projector 250 to project the content near target object 70 within the range of the free space.

On the other hand, when determining that the size of the rectangular region set in the free space is less than the default display size of the content to be projected (No in S86), controller 210 adjusts the display size of the content such that the content falls within the set rectangular region, and then, proceeds to the process in step S87. For example, controller 210 adjusts the display size of the content in the process of the image signal indicating projection image 80. The display size is adjusted such that the aspect ratio of the content is maintained. Note that controller 210 may change the aspect ratio according to the content.

Controller 210 determines the projection position of the content (S87), and then, ends step S7 in FIG. 9. Thus, in step S8 in FIG. 9, the determined content is projected in the free space near the target object (see FIG. 7).

When determining that the size of the rectangular region set in the free space which is the candidate for projection is less than the minimum display size of the selected content (No in S84), controller 210 determines whether or not there is content which has not been selected in content DB 22 (S89).

When there is content which has not yet been selected in content DB 22 (Yes in S89), controller 210 repeats the processes in step S83 and the subsequent steps to the content which has not yet been selected. According to this, if the minimum display size of the content having high priority order in content DB 22 is larger than a size of the free space which is the candidate for projection, the content having the next priority order is selected.

In addition, when there is no content, which has not yet been selected, left in content DB 22 (No in S89), controller 210 determines whether or not there is a free space which has not yet been selected in free space registration list 24 (S90).

When there is a free space which has not yet been selected in free space registration list 24 (Yes in S90), controller 210 repeats the processes in step S81 and the subsequent steps to the free space which has not yet been selected. According to this process, if there is no content which can be projected in the free space closest to target object 70 in free space registration list 24, the next closest free space is selected.

In addition, when there is no free space, which has not been selected, left in free space registration list 24 (No in S90), controller 210 ends the process in step S7 in FIG. 9. In this case, controller 210 controls the projection image such that the content is not projected in step S8 in FIG. 9, and returns to step S1.

According to the above process, the content is projected within the range of free space 61 near target object 70 on the basis of the specifying result of the free space in the detection range such as shelf surface 60 or the like (see FIG. 7). In addition, the content in projection image 80 is switched or the display size of the content is reduced, automatically, according to the size of specified free space 61 (see S84 and S88, and FIG. 8). In addition, when the size of specified free space 61 is equal to or larger than the default display size, the projection position of the content is determined to be the location near target object 70 in free space 61 (S87).

[3. Effects, etc.]

As described above, in the present exemplary embodiment, projection apparatus 100 includes projector 250, range detection unit 230, and controller 210. Projector 250 projects projection image 80 on shelf surface 60 that serves as a projection surface. Range detection unit 230 detects object 70 and object 71 on shelf surface 60. Controller 210 controls projection image 80. Controller 210 specifies target object 70 out of object 70 and object 71 on the basis of the detection result of range detection unit 230. Controller 210 specifies free space 61, on which object 70 or object 71 is not detected on shelf surface 60, on the basis of the detection result of range detection unit 230. Controller 210 controls projection image 80 including the content concerning target object 70 and causes projector 250 to project the content within the range of free space 61.

According to projection apparatus 100 described above, the content concerning target object 70 out of object 70 and object 71, which have been detected on the basis of the detection result of range detection unit 230, is projected within the range of free space 61 not overlapping object 70 or object 71 on shelf surface 60. Thus, the content concerning target object 70 is projected so as to be easily seen by a viewer on shelf surface 60 around target object 70.

In addition, in projection apparatus 100 according to the present exemplary embodiment, controller 210 causes projector 250 to project the content near target object 70 within the range of specified free space 61 (see S87 and FIG. 7). Thus, the content concerning target object 70 out of object 70 and object 71 is projected near target object 70 on shelf surface 60. Therefore, the viewer is easy to recognize that the content is related to target object 70.

In addition, in projection apparatus 100 according to the present exemplary embodiment, controller 210 controls projection image 80 by changing the size of the content on the basis of the range of free space 61 (see S88 and FIG. 8). The size of the content in projection image 80 may be changed by digital zooming by controller 210 or optical zooming by lens driver 510. When the size of the content is changed by digital zooming, the size of projection image 80 itself is not changed. On the other hand, when the size of the content is changed by optical zooming, the size of projection image 80 itself is changed.

In addition, projection apparatus 100 according to the present exemplary embodiment further includes memory 220 that stores a plurality of contents A, B, and C associated with target object 70. Controller 210 controls projection image 80 by selecting content according to the shape of free space 61 out of a plurality of contents A, B, and C on the basis of the range of free space 61 (see S83 and FIG. 8).

Thus, easy-to-see content is projected according to the size and shape of free space 61. Note that projection apparatus 100 may acquire information indicating the content concerning target object 70 from an external device. In addition, projection apparatus 100 may have a communication unit that acquires information indicating the content through wired or wireless communication.

In addition, in projection apparatus 100 according to the present exemplary embodiment, controller 210 specifies a plurality of free spaces 61, 62, and 63 on the basis of the detection result of range detection unit 230. In this case, controller 210 selects the free space having the shortest distance to target object 70 out of free spaces 61, 62, and 63 on the basis of the distance between each of free spaces 61, 62, and 63 and target object 70. Then, controller 210 causes projector 250 to project the content within the range of the closest free space.

Thus, the content concerning target object 70 specified out of object 70 and object 71 is projected within the range of the free space closest to target object 70 on shelf surface 60. Therefore, the viewer is easy to recognize that the content is related to target object 70.

In addition, in projection apparatus 100 according to the present exemplary embodiment, controller 210 detects a change in free space 61 on the basis of the detection result of range detection unit 230 (S4). Controller 210 causes projector 250 to project the content according to free space 61 which has been changed (see FIG. 8). At that time, controller 210 detects the change in the position and shape of free space 61.

Thus, when target object 70 is moved on shelf surface 60, for example, the projection position of the content concerning target object 70 is also changed with the movement of target object 70. Therefore, even when target object 70 is moved on shelf surface 60, projection apparatus 100 can automatically project the content by effectively using free space 61 on shelf surface 60. In the flowchart in FIG. 9, controller 210 performs the process in step S4. However, it is not limited thereto. For example, every time the detection of a free space is finished (S3), the sorting of free spaces (S5) may be performed. That is, controller 210 may not perform the process in step S4.

In addition, in projection apparatus 100 according to the present exemplary embodiment, free space 61 is a region on a flat surface. More specifically, free space 61 is a region on a shelf surface of store shelf 600. Free space 61 is not limited to the region on shelf surface 60. In the case where the projection surface of projection apparatus 100 is set to a wall surface or a floor surface (see FIG. 1 or 2), free space 61 may be a region on the wall surface or the floor surface. Since free space 61 is a region on a flat surface including at least one of shelf surface 60, a wall surface, and a floor surface, the distortion of projection image 80 is suppressed on free space 61, and thus, the content is projected so as to be easily seen.

In addition, projection apparatus 100 according to the present exemplary embodiment further includes range detection unit 230 that detects object 70 and object 71 by detecting the distance between itself and object 70 and object 71. Projection apparatus 100 can acquire information indicating the three-dimensional shape of an object by range detection unit 230, thereby being capable of precisely detecting an object.

### SECOND EXEMPLARY EMBODIMENT

A second exemplary embodiment will be described below with reference to the drawings. The first exemplary embodiment describes the case in which one target object 70 placed within the detection range of an object is specified. However, a plurality of target objects may be specified. The second exemplary embodiment describes the case in which content is projected with respect to each of a plurality of target objects.

Projection apparatus 100 according to the present exemplary embodiment will be described below by omitting, as appropriate, the configurations and operations similar to those of projection apparatus 100 in the first exemplary embodiment.

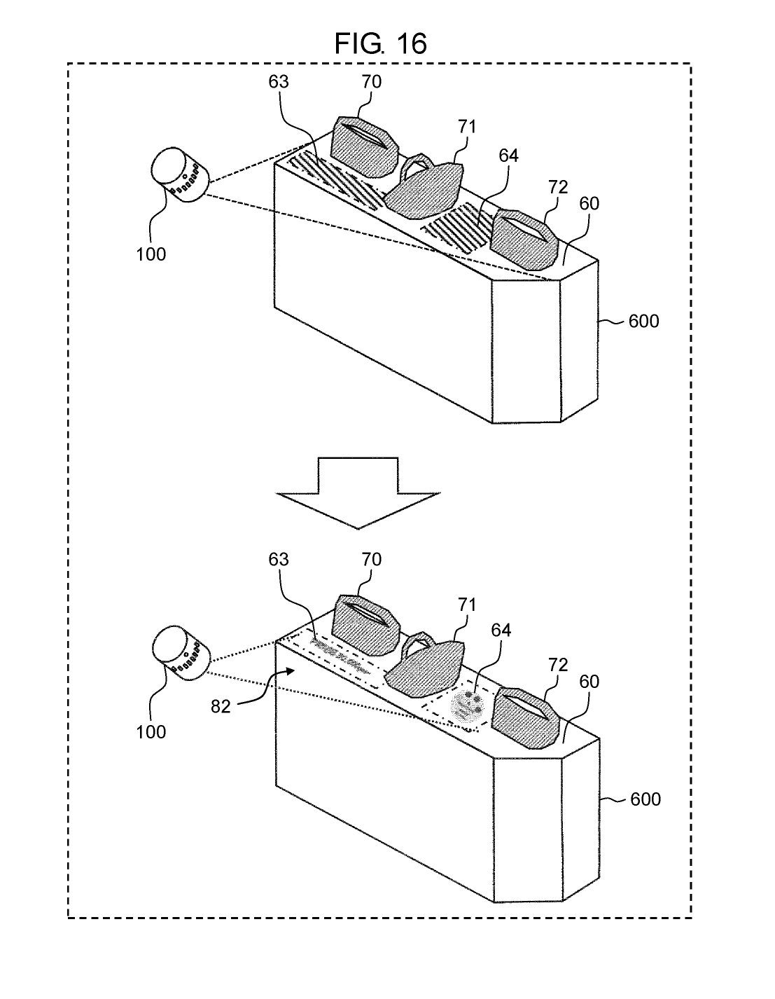

FIG. 16 is a view for describing a projection operation by projection apparatus 100 according to the second exemplary embodiment. Projection apparatus 100 according to the present exemplary embodiment is configured similarly to projection apparatus 100 according to the first exemplary embodiment. The present exemplary embodiment describes the operation of projection apparatus 100 when a plurality of target objects 70 and 72 are placed on shelf surface 60 of store shelf 600 as illustrated in FIG. 16.

Projection apparatus 100 according to the present exemplary embodiment performs the process similar to that in the flowchart in FIG. 9. In the present exemplary embodiment, controller 210 in projection apparatus 100 specifies a plurality of target objects 70 and 72 on the basis of the detection result of objects 70, 71, and 72 on shelf surface 60 in step S2 in FIG. 9 (FIG. 16). In this case, projection apparatus 100 projects projection image 82 including the contents concerning target objects 70 and 72 as illustrated in FIG. 16. Projection apparatus 100 projects the content concerning target object 70 on free space 63 near target object 70 and projects the content concerning target object 72 on free space 64 near target object 72 by projecting projection image 82.

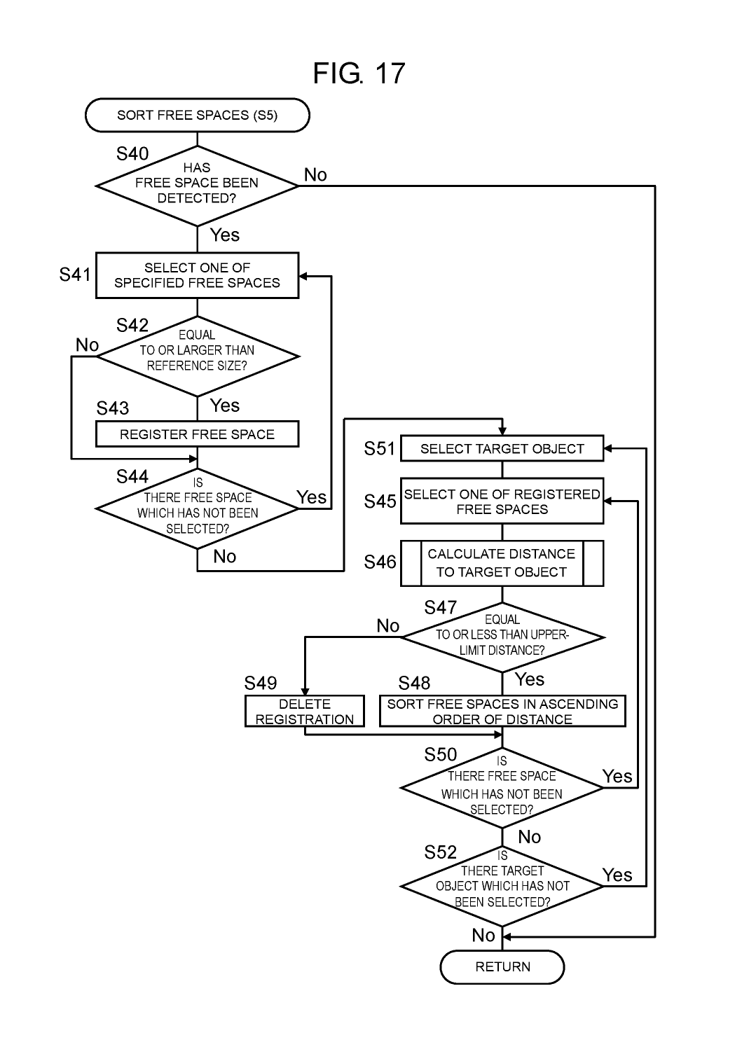

FIG. 17 is a flowchart illustrating the process for sorting free spaces in the present exemplary embodiment. In step S5 in FIG. 9, controller 210 executes the process in the flowchart in FIG. 17 in place of each process in FIG. 12.

In the flowchart in FIG. 17, when proceeding to “No” in step S44, controller 210 selects one target object out of target object 70 and target object 72 which have been specified (S51).

Next, controller 210 registers free spaces which are the candidates for projection in free space registration list 24 for each of the selected target objects (S45 to S50).

Then, controller 210 determines whether or not there is a target object, which has not been selected in step S51, among target object 70 and target object 72 which have been specified (S52). When there is a target object which has not yet been selected among target object 70 and target object 72 (Yes in S52), controller 210 repeats the processes in step S51 and the subsequent steps to the target object which has not yet been selected.

When there is no target object, which has not been selected, left among target object 70 and target object 72 which have been specified (No in S52), controller 210 ends the process in step S5 in FIG. 9, and proceeds to step S6.

Thus, controller 210 can select a free space, which is the candidate for projection, for each of target object 70 and target object 72 which have been specified in ascending order of distance.

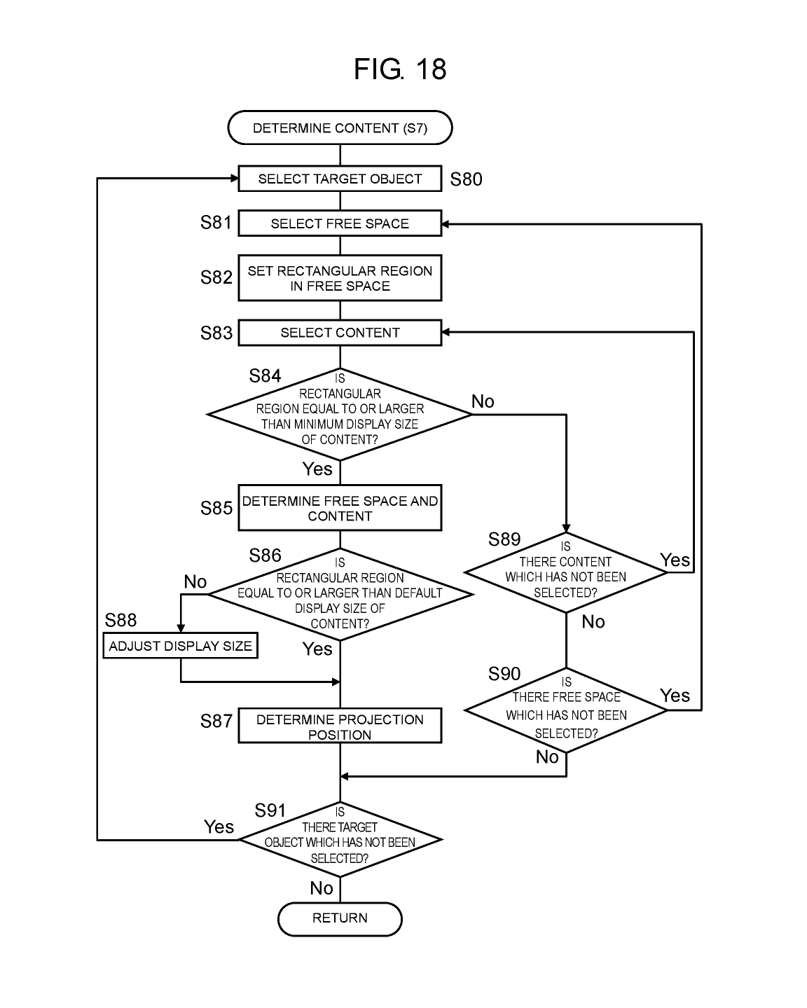

FIG. 18 is a flowchart illustrating the process for determining content in the present exemplary embodiment. In step S7 in FIG. 9, controller 210 in projection apparatus 100 executes the process in the flowchart in FIG. 18 in place of each process in FIG. 15.

In the flowchart in FIG. 18, controller 210 firstly selects one target object out of a plurality of target objects 70 and 72 (S80). For example, controller 210 selects a target object in ascending order of distance to projection apparatus 100.

Next, controller 210 determines the content to be projected with respect to the selected target object (S81 to S90).

Then, controller 210 determines whether or not there is a target object, which has not been selected in step S80, among target object 70 and target object 72 which have been specified (S91). When there is a target object which has not yet been selected among target object 70 and target object 72 (Yes in S91), controller 210 repeats the processes in step S80 and the subsequent steps to the target object which has not yet been selected.

When there is no target object, which has not been selected, left among target object 70 and target object 72 which have been specified (No in S91), controller 210 ends the process in step S7 in FIG. 9, and proceeds to step S8.

In this case, controller 210 excludes the free space on which the content concerning the target object that has been already selected is determined to be projected from the options for free spaces in step S83. Thus, projection apparatus 100 can project the content concerning each target object in each of the free spaces near each of target objects 70 and 72.

As described above, in projection apparatus 100 according to the present exemplary embodiment, controller 210 specifies a plurality of target objects 70 and 72 on the basis of the detection result of range detection unit 230. In this case, controller 210 causes projector 250 to project contents concerning each of target objects 70 and 72 (S80 to S91). Thus, projection image 82 including both the contents concerning the respective target objects 70 and 72 is projected.

### OTHER EXEMPLARY EMBODIMENTS

As described above, the first and second exemplary embodiments have been described above as an illustration of the technology disclosed in the present application. However, the technology in the present disclosure is not limited to this, and can be applied to embodiments in which various changes, replacements, additions, omissions, etc., are made. Furthermore, an embodiment can be formed by combining each component described in the exemplary embodiments described above. The other exemplary embodiments will be described below.

In the above exemplary embodiments, projection apparatus 100 includes range detection unit 230 as a detector. However, it is not limited thereto. In place of range detection unit 230, projection apparatus 100 may include an imaging unit, such as a CCD camera, that captures an image with visible light (RGB) as the detector. For example, controller 210 may specify a target object and a free space by analyzing an image captured by the imaging unit. Alternatively, projection apparatus 100 may include, as the detector, range detection unit 230 and an imaging unit. In this case, controller 210 may specify a target object and a free space on the basis of the detection image generated by range detection unit 230 and the image captured by the imaging unit.

In the above exemplary embodiments, shelf surface 60 is set as the detection range for an object and the projection surface by projection apparatus 100. The detection range for an object may not be set beforehand. For example, projection apparatus 100 may control driver 110 or the like on the basis of the detection result of range detection unit 230 to determine the detection range for an object and the projection surface.

In the above exemplary embodiments, projection apparatus 100 includes driver 110 that changes the projection direction. However, projection apparatus 100 may not include driver 110. For example, in the case in which projection apparatus 100 projects a projection image only in a predetermined region on a projection surface, the maximum angle of view may be set such that the projection image can be projected on the entire projection surface. Thus, the driver may be eliminated.

In the above exemplary embodiments, a free space is a region on a flat surface. However, the free space is not limited to the region on a flat surface. The free space may be a region on a surface having irregularities to an extent by which a viewer is easy to recognize the projected content.

In the above exemplary embodiments, shelf surface 60 is set as the projection surface of projection apparatus 100. However, a surface composed of two or more flat surfaces may be set as the projection surface of projection apparatus 100. For example, the surface composed of shelf surface 60 and a wall surface may be set as the projection surface of projection apparatus 100.

As described above, the exemplary embodiments have been described above as an illustration of the technology disclosed in the present application. The accompanying drawings and the detailed description are provided for this purpose.

Thus, elements appearing in the accompanying drawings and the detailed description include not only those that are essential to solving the technical problems set forth herein, but also those that are not essential to solving the technical problems but are merely used to illustrate the technology disclosed herein. Therefore, those non-essential elements should not immediately be taken as being essential for the reason that they appear in the accompanying drawings and/or in the detailed description.

The exemplary embodiments above are for illustrating the technology disclosed in the present disclosure, and various changes, replacements, additions, omissions, etc., can be made without departing from the scope defined by the claims and equivalents thereto.

The projection apparatus according to the present disclosure is applicable to various uses for projecting an image onto a projection surface.

What is claimed is:

1. A projection apparatus comprising:
a projector that projects a projection image on a predetermined projection surface;
a detector that detects an object on the predetermined projection surface; and
a controller that controls the projection image,
wherein the controller
specifies a predetermined target object out of the object, based on a detection result of the detector,
specifies a free space on which the object is not detected on the predetermined projection surface, based on the detection result of the detector, and
causes the projector to project content concerning the predetermined target object within a range of the free space by controlling the projection image including the content.

2. The projection apparatus according to claim 1, wherein
the controller causes the projector to project the content near the predetermined target object within the range of the free space by controlling the projection image.

3. The projection apparatus according to claim 1, wherein
the controller controls the projection image by changing a size of the content, based on the range of the free space.

4. The projection apparatus according to claim 1, further comprising
a storage unit that stores a plurality of contents associated with the predetermined target object,
wherein the controller controls the projection image by selecting content according to a shape of the free space out of the plurality of contents, based on the range of the free space.

5. The projection apparatus according to claim 1, wherein
the free space is one of a plurality of free spaces, and
when the controller specifies the plurality of free spaces, based on the detection result of the detector,
the controller
selects a free space closest to the predetermined target object out of the plurality of free spaces based on a distance between each of the plurality of free spaces and the predetermined target object, and
causes the projector to project the content within a range of the closest free space.

6. The projection apparatus according to claim 1, wherein
the object is one of a plurality of objects,
the predetermined target object is one of a plurality of predetermined target objects,
the controller specifies the plurality of predetermined target objects out of the plurality of objects, based on the detection result of the detector, and
when the controller specifies the plurality of predetermined target objects, based on the detection result of the detector,
the controller causes the projector to project contents concerning each of the plurality of predetermined target objects.

7. The projection apparatus according to claim 1, wherein
the controller
detects a change in the free space, based on the detection result of the detector, and
causes the projector to project content according to the free space that has been changed.

8. The projection apparatus according to claim 1, wherein
the free space is a region on a flat surface.

9. The projection apparatus according to claim 8, wherein
the flat surface includes at least one of a shelf surface of a store shelf, a wall surface, and a floor surface.

10. The projection apparatus according to claim 1, wherein
the detector detects the object by detecting a distance from the detector to the object.
